(19) United States
(12) Patent Application Publication
(10) Pub. No.: US 2014/0013248 A1
(43) Pub. Date: Jan. 9, 2014

(54) SYSTEM AND METHOD FOR ASSOCIATING A CONVERSATION

(71) Applicant: Life of Two, San Francisco, CA (US)

(72) Inventor: Tyson Verstraete, San Francisco, CA (US)

(73) Assignee: Life of Two, San Francisco, CA (US)

(21) Appl. No.: 13/856,362

(22) Filed: Apr. 3, 2013

Related U.S. Application Data
(60) Provisional application No. 61/619,665, filed on Apr. 3, 2012.

(51) Int. Cl. H04L 12/58

(52) U.S. Cl. CPC H04L 51/16
USPC 715/758

(57) ABSTRACT

A system and method for associating a conversation with one or more events is provided. Conversations are allowed to take place around newly created events within a social network environment. This conversation is associated to the event and modifies the event the moment the association takes place. Each conversation is threaded within the event and each event is placed in time sequence and reordered each time the event or the conversation is modified.

### CLAIM OF PRIORITY

This application claims priority to U.S. Patent Application No. 61/619,665, filed Apr. 3, 2012, entitled “A System and Method for Associating a Conversation with An Event,” which is hereby incorporated by reference herein in its entirety.

### BACKGROUND

Changes in the world of Instant Messaging (IM) and chat solutions have been limited over the past twenty years. Person-to-person chat and multi-person chat (or chat groups) still tend to be person focused and primarily a series of exchanged messages back and forth. These systems are well known to those skilled in the art and populate every known computer system that offers any form of communication.

One of the more recent additions to the world of communications has been the arrival of social networking. The main change in social networks has been a conversation mode that allows discussion around objects like photographs. In advanced systems like the ones available from Facebook™ it is possible to upload a photo and open a conversation around the uploaded object. Such systems scratch the surface of emulating real human conversation but a great deal more is needed to emulate real human interaction.

When communication takes place within an intimate relationship, especially with our spouse or family members, we tend to open several conversations at once and our minds multitask through all the open topics and deal with things based on both our feelings and pressing need. For example I might be planning a dinner out with my wife in a few days and then it moves to booking a reminder for the dinner out and then the topic jumps to “what are going to eat tonight” and then moves to building a shopping list for the coming week of food consumption. These types of multilevel conversations occur because the opening of one topic reminds us of other conversations that must also be discussed. In normal human conversation we don't want to close one conversation in order to open another one. In today's IM and social networking systems it is not possible for two people to open more than one simultaneous conversation and discuss them all. Within intimate relationships we also tend to track each other by what we do throughout each day and week. We assign tasks to each other and have conversations around tasks, where we are going, where we have been, what we have spent money on, what appointments we have booked, etc. There is no useful system for integrating both specific activities with the conversations around those activities. Existing systems do not attempt to integrate them in a way that helps conversation.

When dealing with a spouse, a family member or a relative the context of a conversation, and everything that happens in the conversation becomes very important and relevant. Information like the time the event took place can be important or the comments that took place around the creation of that event are important. As the intimacy increases even the feelings that were shared during the exchange of comments are important. To make digital communications more relevant all of these subtleties within our human exchanges should be recognized, shared and recorded when possible and when desired. A summary of all the events that take place needs to be summarized and shared between intimately related people.

Therefore be it resolved a solution is still required to solve the plethora of problems presented when two closely related people communicate and share a life together. A solution is still needed that can share not just a few sentences but can summarize in one location all the events in a day and week between two or more closely related people.

### SUMMARY

To address these concerns a user interface is describes that provides an activity screen for two or more users to share a range of events and also allows for discussion to take place. The activity screen is made up of specific events and the conversations around those events. The activity screen also allows multiple conversations to be opened between the same two people. The term events used within this specification can refer to a wide range of digitally programmed situations that can take place on a computer. Each event has the property of being identified by a time and date and in some embodiments an identifier can be added to assist with identification. In some embodiments titles are not required as the information is so visual, like a photograph that a title is not required. Some examples of events include the creation of a calendar entry, making of a todo entry, starting a task list, building a grocery shopping list, performing a credit card transaction, arriving at a certain Global Positioning Satellite (GPS) location, adding an address to an address book or opening a conversation for discussion. In other exemplary examples external events like door bell ringing, a requested front door photograph, a child's GPS location, home alarm triggers and other specialized events can also be digitally programmed to send their events to the activity screen.

In the activity screen it is possible for the same two people to open any number of conversations between themselves and discuss them all simultaneously. The term activity screen refers to a user interface (UI) screen presented on a computer managed by a computer program. The term activity monitor application will be used to refer to this computer program that managed all the input and output requirements for the activity screen. The activity monitor application is a program that merges the concepts of a universal inbox and the conversation windows within chat programs. Any registered action within a computer system can result in the appearance of a new event within the activity screen thanks to the activity monitor application. Each new event that appears in the activity screen provides a user interface dialogue window for a conversation to take place around that event. The activity screen of different computer systems are then shared via a traditional data communications protocols, like TCP/IP. For one skilled in the art TCP/IP represents just one communication method that is the heart of the Internet data exchange. Besides using protocols like TCP/IP activity screens can be shared over wireless technologies like GSM, CDMA, Edge, UMTS, iDEN, LTE, WiFi, Bluetooth and all forms of wireless protocols being developed. Communication between different computer systems can be synchronized using a traditional cloud computing paradigm. This is well known in the computer field today but essentially this means that activities on each of the connected activity screens is synchronized through a common access point that is always available. If one of the one or more connected computers is not activity when a change takes place the synchronization cloud remembers the change and provides it later when the computer does become available.

Once dialogue messages are entered around a specific event they can be shared simultaneous to all users sharing the same activity screen. Any user sharing the activity screen can enter a dialogue message and once a dialogue message is entered and shared it is then associated and saved with that specific event. If not all external computer systems can't save dialogue messages, for example a front door bell, they will be sent to only those computer systems that are capable of sharing and saving them. All of the dialogue messages entered are kept in sequential order based on when they were entered, and they are permanently tied to that specific event from that time forward in each capable computer system sharing the activity screen. Whenever any user enters new dialogue messages to a previous event the ordering of all special events will be changed and the new dialogue message will cause that special event to become the most current special event. This could mean the event is placed on the top of all events, it could mean it is placed on the bottom of all events. The implementation of the reordering is based on the programmatic logic used when ordering, for example top down or bottom up. If the event itself is changed, for example a new item is added to the shopping list, that will also cause the event and all dialogue message to be reordered to the top of all activities displayed on the activity screen. In this respect the activity screen is like a shared universal inbox display built for sharing all events of interest that take place across many computer systems.

### BRIEF DESCRIPTION OF THE DRAWINGS

FIG. 1 is an illustration of the first page of an exemplary activity screen.

FIG. 2 is an illustration of the second page of an exemplary activity screen.

FIG. 3 is an illustration of the first page of an exemplary activity screen after an update and reordering has taken place.

FIG. 4 is an illustration of an exemplary design for creating an activity monitor application to generate an activity screen.

FIG. 5 is an illustration of a second exemplary design for creating an activity monitor application to generate an activity screen.

FIG. 6 is an illustration of an exemplary embodiment of the activity screen in a compressed format.

FIG. 7 is a data flow diagram showing the steps in one embodiment of the activity monitor application.

### DETAILED DESCRIPTION OF DRAWINGS

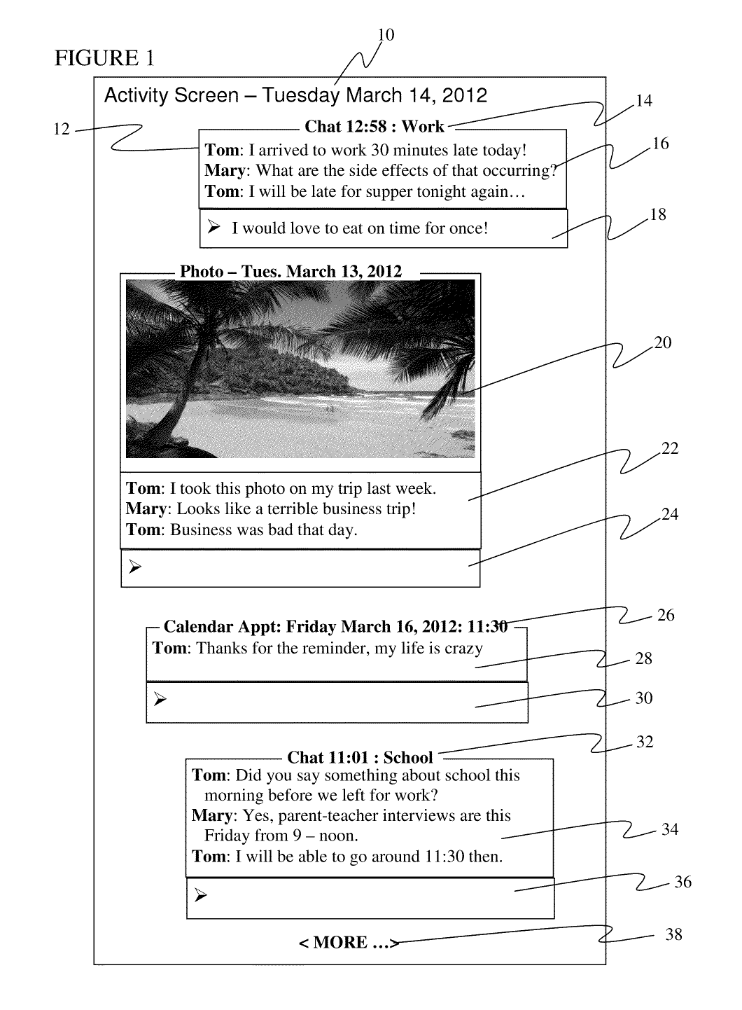

Turning to FIG. 1 there is an illustration of the first page of an exemplary activity screen 10. In this example the activity screen 10 shows a date of Tuesday Mar. 14, 2012 followed by a series of smaller screens 12. The first smaller screen 12 is made up of three components a title 14, the content 16 and the dialogue input area 18. In this exemplary illustration each event box 12 represents a separate event within the activity screen 10. The first component 14 represents a title, in this case the title is a ‘Chat’ event opened at 12:58 with a name ‘Work’. The second component 16 is the exchange of messages or current content within that chat event called Work. For one skilled in the art each message can be identified in many ways. In this embodiment an actual name is used, in multi-layered chat this can be useful. In two person conversations a picture can be used for each person, often a different color can be used for each section of words and in other cases the work ‘me’ is used for information I have typed. The third component 18 is the dialogue input area to add dialogue messages to the event called Work. In this embodiment a simple sideways diamond is used to indicate that input can be entered here. In other embodiments there could be no prompt, or a long line or a flashing cursor the choices for input indicators are numerous. The exact format of these components is not essential and the title 14 is not required to represent a specific event. When two people are in an intimate relationship it is very possible to scan a given event box 12 to determine what each event is.

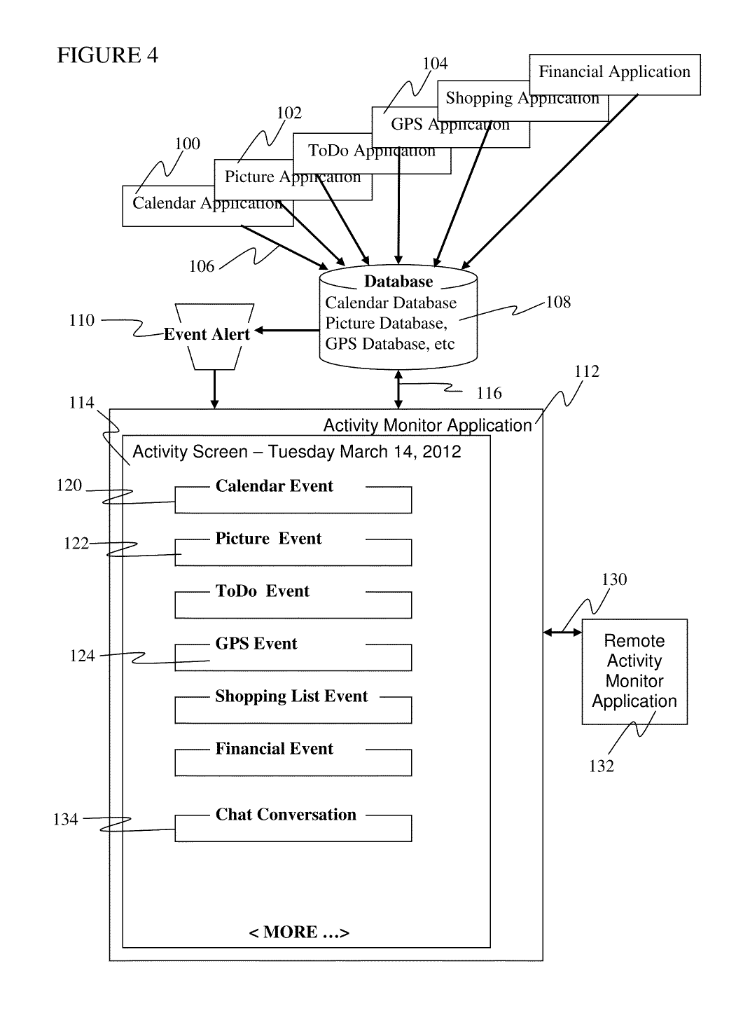

In this exemplary illustration the chat event ‘Work’ 14 is the most recent event that has taken place between all the people sharing this activity screen 10. The next most recent was a picture 20 that was taken and shared to the activity screen. As with the chat event the Photo event from Tuesday Mar. 13, 2012 allows a discussion to take place 22 and provides a dialogue input area 24 to additional comments to the conversation. Following the Photo event is a calendar application event 26. The calendar appt event 26 indicates a new calendar appointment was created for Friday Mar. 16, 2012 at 11:30. Around this calendar application creation 26 all people sharing this screen can have a conversation 28 via the dialogue input area 30. Following the calendar appointment 26 another chat event 32 has been created around a topic ‘School’ 32. This second chat event between Tom and Mary provides a separate and unique conversation 34 and a separate dialogue input area 36. The two participants can have a context sensitive conversation that is about ‘School’ and not related to the more recent conversation around ‘Work’ 14. Most of these events displayed in this example originated outside the activity monitor program (illustrated in FIG. 4) except for the Chat events ‘Work’ 14 and ‘School’ 32.

Depending on the computer system used and its capabilities there can be many pages of events within the activity screen 10. For one skilled in the art it is well known that in a touch screen capable system the user might simply scroll their figure across the screen to see additional activity screens 10 of information. In other less advanced systems the user might be shown a prompt like ‘MORE’ 38 to move to the next activity screen 50. For simplicity within this application a ‘MORE’ 38 indicator is shown to allow for a clearer transition to the next Figure.

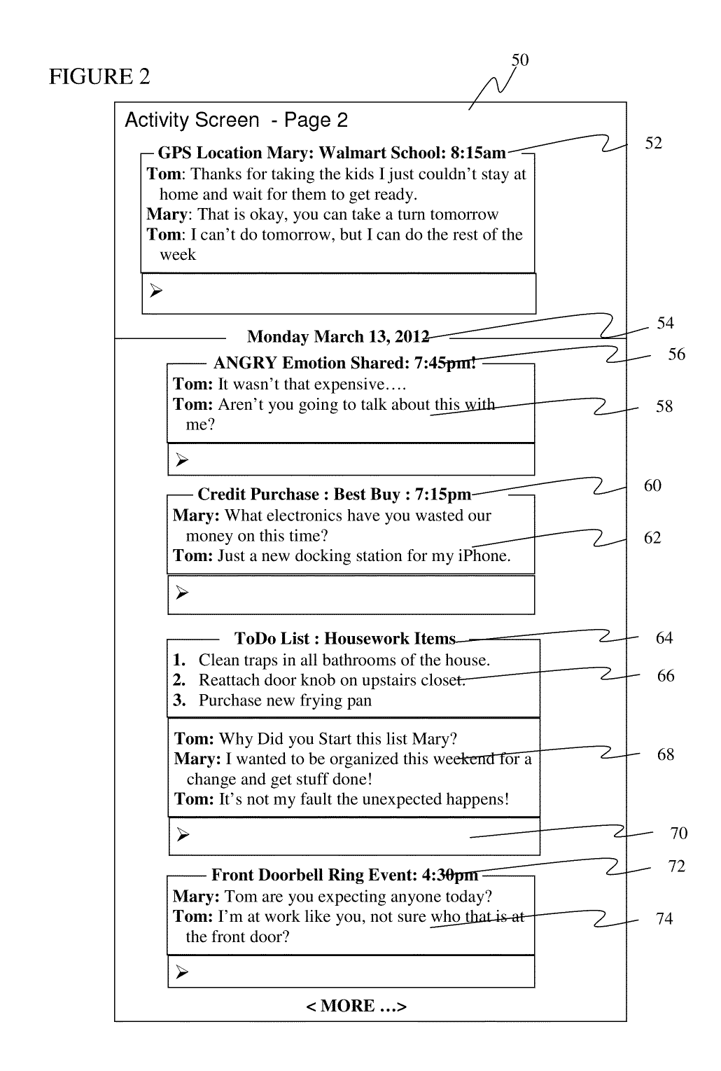

Turning to FIG. 2 there is an illustration of the second page of an exemplary activity screen 50. This section activity screen 50 there are another set of older events shown to illustrate the diversity of the activity screen 50. The first is an indication of Mary's GPS location as Walmart school with a time of 8:15am 52. There might be many ways to implement this event, for example a GPS tracking application on a computer system might be programmed to generate a special event when a specific location is reached. When a location of interest is reached, like taking the kids to their school, a GPS application shares that information with the activity screen 50.

In this exemplary example the activity screen 50 is a continuous listing of all activities that have taken place without breaking days or weeks into separate activity screens. In this illustration a date of Monday Mar. 13, 2012 divider 54 has been used to easily indicate to the viewer that events below this line are for the previous day. Other implementations could use a different color scheme, or some form or tiled overlapping screens or a variety of visual effects to distinguish days.

After the date indicator 54 the last thing that happened on Monday March 13^{th} was an emotion action 56 was shared at 7:45pm. This action could be performed through a button choice, a touch of a screen or some other programmed action. The illustration shows that Tom has commented 58 but in this example Mary has said nothing at all.

The next example is a credit purchase from Best Buy at 7:15pm 60. In this example there is a conversation 62 that takes place around the credit card purchase and it isn't a happy conversation. It is likely this purchase that caused the Angry Emotion 56 to be shared later that same evening. To track a credit card purchase in this manner could be performed in several ways. Tom could be using new wireless wallet technology or Near Field Communication (NFC) methods being employed to complete purchase transactions. Alternatively Tom's banking interface software could have detected the larger purchase, based on a maximum size threshold configuration setting, and notified the activity screen 50.

Finally the last example shown on the activity screen 50 is the creation of a ToDo list 64. The ToDo list 64 may have originally been created in the ToDo application. The ToDo application could be any number of applications, like the Grocery List creation application, the task list application, the calorie monitoring application or even the heart monitoring application. In this illustration the ToDo list has its own set of data 66, followed by a conversation 68 around the ToDo list and its contents. After the conversation area 68 is the usual dialogue input area 70 to allow everyone sharing this activity screen to provide their comments. In this exemplary embodiment there is an example of a Front Doorbell Ring Event 72 occurring at 4:30pm. Tom and Mary have a brief conversation as they are both at work and surprised someone is trying to get into the house. The front door bell might be connected to their home automation system and a message is generated and sent via TCP/IP over the Internet to their handheld computer. This message could also be an SMS or MMS message sent via a wireless carrier to their smartphone or tablet device. In some circumstances they might be able to get onto their home system through a secure Virtual Private Network (VPN) connection and ask for a live feed from the web cam they have set up in their home to watch for break-ins.

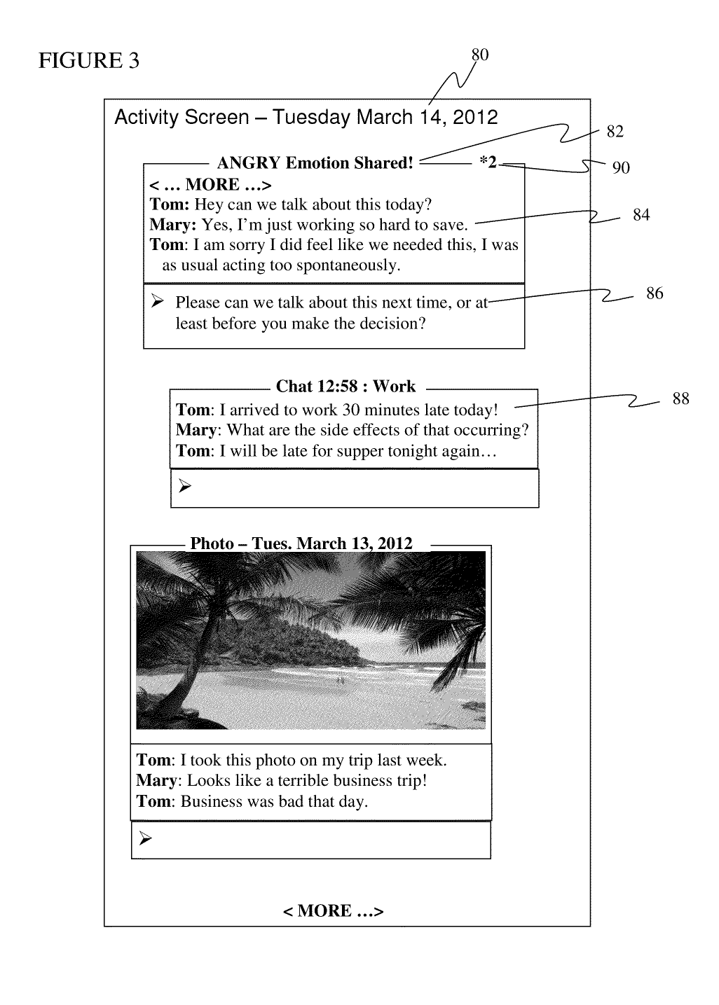

Turning to FIG. 3 there is an illustration of the first page 80 of an exemplary activity screen after an update and reordering has taken place. From FIG. 2 we see the Angry Emotion 82 that was shared the previous day has been reordered to the top of Tuesday Mar. 14^{th}. This can happen for several reasons; in this illustration Tom and Mary have re-opened the conversation 84. In fact the messages have exceed the normal amount configured to be displayed so an indicator of ‘MORE’ and a number 2 is shown 90. There are many ways to indicate there are additional messages that can be expanded, in this embodiment the user might just have to click on the number ‘2’ 90 and the other messages will appear. Messages in the conversation continue to be added 86, which will further increase the number count from ‘2’ to ‘3’ 90 and it will also update the timestamp information on this event 82.

Other events listed on this activity screen 80 for this day are pushed downwards to make room for the reordering. The previous first item Chat about Work 88 gets moved lower in the time sequence. This is an implementation choice and there could be other methods for reordering the conversation that works in a specific environment.

Turning now to FIG. 4 there is an illustration of an exemplary design for creating an activity monitor application 112 to generate an activity screen 114. Along the top are a series of applications which are only a small subset of all possible applications that could be linked to the Activity Monitor Application 112. Some of the example applications shown here include the calendar application 100, the picture application 102 and the GPS application 104. The goal of any design would be to allow for an expandable design model were applications could be added or removed easily. In many cases a direct Application Program Interface (API) is used, in other cases a messaging paradigm over a protocol like TCP/IP is used, for each environment a different choice might be better over another. For one skilled in the art of programming such designs are common and easily referenced.

In this illustration the applications 100, 102, 104 communicate to a common database 108 through an interface 106 that could involve direct database API calls to the database 108. When available the database 108 might offer event alerts 110 that would inform the activity monitor application 112 of changes to the database 108. Such database 108 features often require the program 112 to register themselves and be linked 116 to the database 108. In this example the activity monitor application 112 is watching for any changes to the database 108 over link 116 and has been configured to take action when specific changes are noticed. For illustration purposes changes to the calendar database, picture database and GPS database 108 are shown, many others can also be used. Changes within these parts of the database 108 result in events appearing on the activity screen 114. When a calendar appointment is added a calendar event 120 appears on the activity screen 114. If that calendar entry is modified, moved or deleted that event makes a change to the activity screen 114. Similarly if the picture database 108 is changed a picture event 122 appears in the activity screen 114. In this case the user might have the choice to include or ignore adding it to the activity screen 114 should they not want to congest the screen with too many photos. Similarly if an important GPS event occurs a GPS event 124 might appear on the activity screen 114. So it goes for ToDo events, shopping list events, financial events, contact list events, phone call events and all other events that the activity monitor program 112 has been asked to monitor.

During the process of updating the activity screen 114 the activity monitor program 112 will also inform other linked 130 remote activity monitor applications 132. This linkage occurs through the course of communication that takes place between individuals. In our previous discussions this linkage 130 could be to a spouse, kids, other family members, important work colleagues or ones closest friends. The actual link itself could take place over a wired or wireless TCP/IP connection. It might also be a WiFi link, a NFC link or even a Bluetooth connection. As the remote activity monitor application 132 receives updates it can act upon them in various ways. It could simply updates its own activity screen 114 or it could also decide to make changes to the database it's maintaining on the remote system. In this respect the mirroring of activity screens 114 could also provide a way of minor some amount of configured database activity between two or more systems.

Not all events have to originate within the database 108. The activity monitor application 112 might also offer local functionality for the user. In this illustration one such local functionality is the Chat Conversation window 134. The Chat conversation 134 allows for a spontaneous exchange of thoughts without an external database 108 event taking place.

When changes take place on the activity screen 114, whether originated from the database 108 or originally within the activity monitor application 112 the change is replicated back to the database 108. These changes typically are conversations that are opened around the event itself and those conversations will be associated to the event for later retrieval.

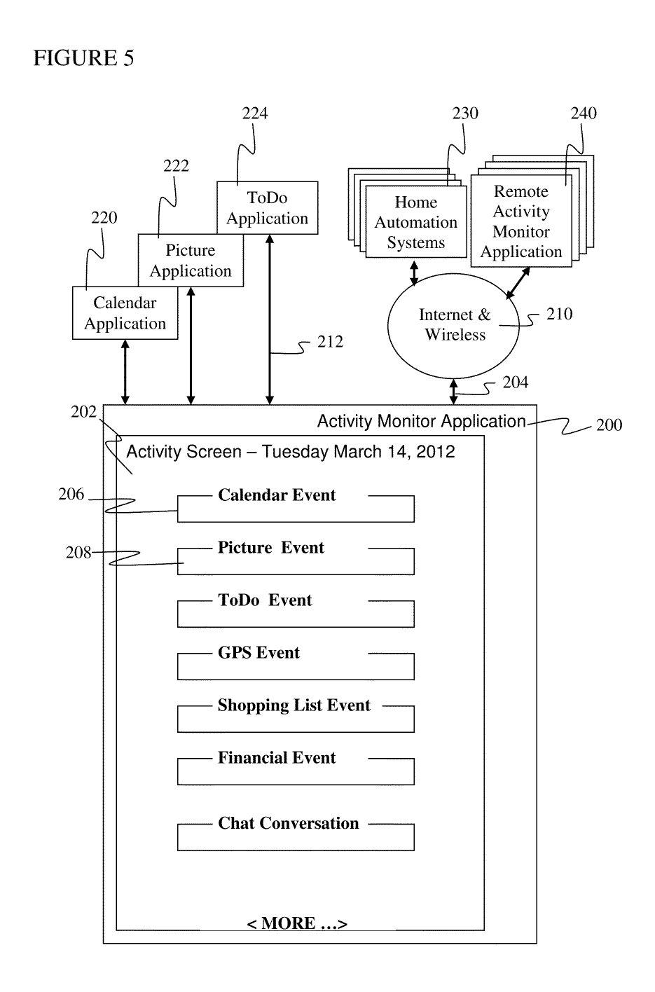

Turning now to FIG. 5 there is an illustration of a second exemplary design for creating an activity monitor application to generate an activity screen. In this embodiment the activity monitor application 200 uses a variety of methods 212, 204 for communicating with remote sources of information. Some of these methods could be similar to described in FIG. 4 or they could be different. For example a local set of API calls could be used for local applications 212 and a TCP/IP messaging passing interface 204 could be used for remote applications. It is also possible to use TCP/IP communication protocols for both local applications 212 and remote applications 204. For one skilled in the art the use of TCP/IP locally within the same CPU-based computing platform is well know.

In this exemplary embodiment the activity monitor application 200 maintains the activity screen 202 by communication means 212, 204. Where necessary a wide area network like the Internet 210 is used to bridge distance. This wide area network could also involve the user of Wireless technologies like WiFi, Bluetooth or NFC. In other cases public wireless networks like GSM, GPRS, Edge, LTE, UMTS, CDMA, iDEN and all future 4G and 5G technologies could also be involved in data exchange.

In these designs the applications are cooperating for a shared message exchange either over TCP/IP types links or through API calls. So when a new calendar appointment is made by the calendar application 220 a call or message is passed to the activity monitor program 200 to change the activity screen 202. Similarly when a remote activity monitor application 240 has a change a message is also passed to the local activity monitor application 200 to update its activity screen 202. Unique home automation systems or similar custom solutions could also be programmed to send a message through a TCP/IP interface to the activity monitor application 200. Such messages are already common in most home security systems today. In these cases the activity monitor application 200 might have to be programmed to be flexible in the format of the message it is prepared to receive for display on the activity screen 202. Such systems would be extremely valuable to a husband and wife team that might be monitoring their house for theft, fire or simply to monitor the temperature.

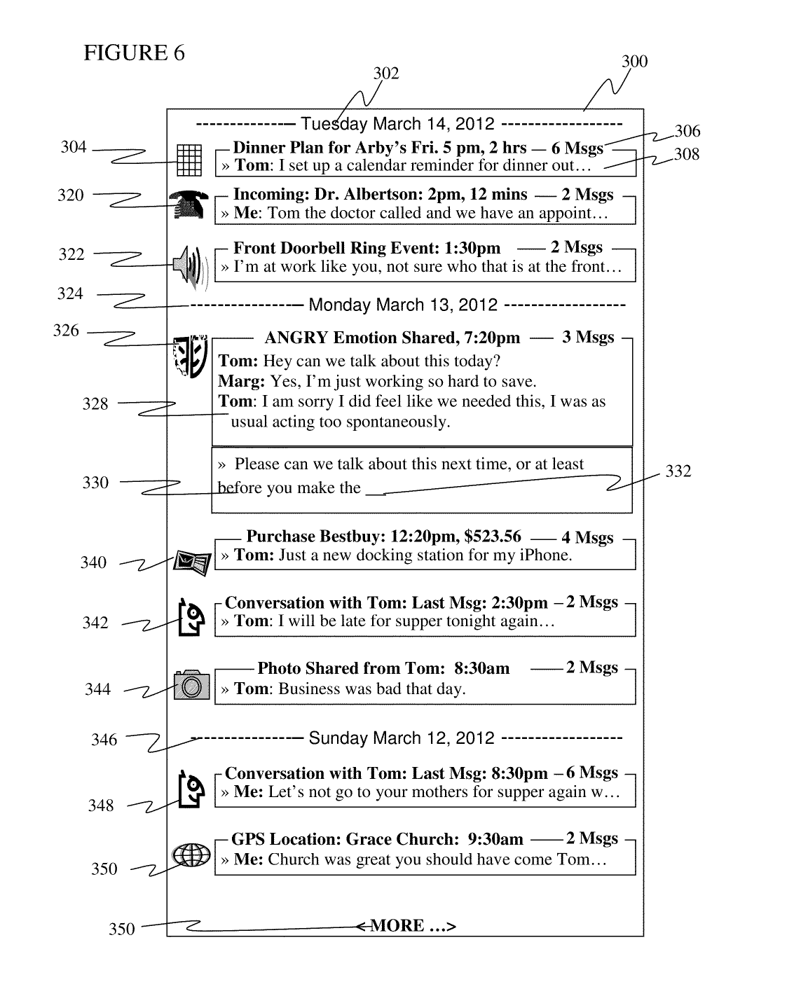

Turning now to FIG. 6 there is an illustration of an exemplary embodiment of the activity screen 300 in a compressed format. The activity screen 300 shown in FIG. 6 is closer to a traditional universal inbox screen that lists the events that have occurred, in time related order and with icons representing each event. Each day of events is separated by a date line indicator 302, 324, 346 to help the user quickly locate events on a given day. In the compressed form each event has an identification icon like a calendar event 304, it has a title line that can show any number of helpful information. For the calendar appointment the title line 306 shows the appointment subject, the location, the appointment time and the appointment length. Each compressed summary line also shows the last exchanged conversational message 308. In other embodiments there could be several lines shown, or none whatsoever the implementer would have many choices on what display could work best for any given computer system.

The next event was a telephone call 320 shown from the doctor's office, followed by an indication that the front doorbell has been rung 322. After the start of Monday Mar. 13, 2012 events 324 we have the sharing of an emotion 326 which is different from the other events shown thus far. When the user selects an event, like the angry emotion event 326 it opens the event on the same screen to reveal some of the conversation 328 and it provides the field for input 330. As part of this embodiment the last three messages are shown and if there should be an excessive number of messages the user might have to perform a scrolling action to see older messages in the conversation. Also shown in this embodiment is the fact that the user has started to type a message 330 and the cursor 332 is present and showing the user where they are located. Once the user is complete this message will be moved to the top of Tuesday Mar. 14, 2012 (302) and will become the most current item on the activity screen 300.

After the angry emotion 326 is a purchase that was made from Bestbuy 340, a previous conversation 342 and a photo that was shared 344. Then the activity screen moves to the previous day 346 and there is another conversation 348 and a GPS location 350. Finally there is shown a ‘More’ indicator 350 telling the user additional information follows, but this could be an arrow, three dots ( . . . ), a scroll bar or nothing at all. When using touch screen technology the user's attempts to scroll down will simply stop working and this will indicate no additional information can be found on this activity screen.

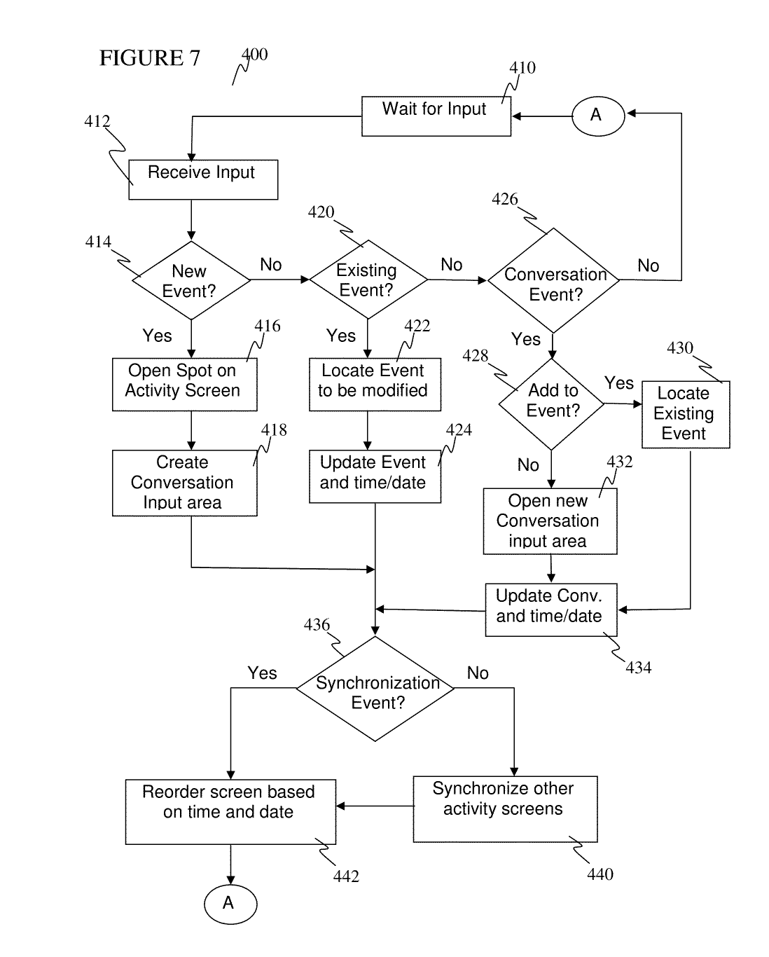

Turning now to FIG. 7 there is a data flow diagram showing the steps in one embodiment of the activity monitor application 400. In this exemplary embodiment the activity monitor application 400 is waiting for input 410 until changes are required for the activity screen. Once input is received 412 it looks to see if the input is a new event 414. A new event could be from a local application like a calendar, today, phone, wireless wallet, GPS or some other sub-system of the computer or it might be a remote event like another connected activity screen has made a change, a home automation system has sent a message or perhaps a child's GPS is moved to a specific location. If this is a new event then a new spot on the activity screen is opened 416, a new conversation input area is created 418 and then a series of common home keeping activities are performed. First a check is made to see if this event was a synchronization event 436 received from another remote activity monitor application. If not then a message is sent to all other connected activity monitor applications to synchronize their screens 440 and the current activity screen is reordered based on time and date of all displayed events 442. Once complete the system returns and waits for more input events. If this was a synchronization event 436 then the only step is reorder the screen based on time and date 442 and then go back to wait for more events.

If this was not a new event a check is made to see if it applies to an existing event 420. If the event applies to an existing event, for example a new comment has been added to the event, then the event is located 422 and then the event is updated 424 with the information and the time and date are changes. Then the common check is made to see if this was a synchronization event 436 and if not it synchronizes the change 440 and then reorders the screen based on time and date information. If the new event did not apply to an existing event then it could be a conversation event 426. If the event does apply to a conversation then we check to see if it applies to an existing conversation 428. If it does then the conversation is found 430 and the conversation is updated with the information and the time and date are updated 431. Otherwise we open a new conversation 432 and we update that new conversation with the new information and update the time and date 434. In both cases we then go to check to see if this was a synchronization event 436 and if not we send a synchronization message off to all other connected activity screens 440 and then we reorder the activity screen based on time and date 442 and proceed to return to wait for input 410 via connection (A). If we do not recognize the event then we ignore it and return direction to wait for input 410.

What is claimed is:

1. A system and method for constructing a shared activity screen for communications, composed of events and conversations comprising:
detecting one or more events within a computer system having a time and date associated with them,
displaying the one or more detected events on the activity screen,
allowing a conversation to be opened around the one or more detected events,
allowing two or more simultaneous conversations to be opened between the same two people on the activity screen,
synchronizing every change made to the activity screen with one or more associated activity screens and
each time a change is made to the activity screen reordering the activity screen using the updated date and time information.

2. The method of claim 1, where the reordering of events further includes:
(a) allowing conversations to be created and associated within an event,
(b) updating the time and date when a conversation is created within an event and
(c) updating the time and date each time the conversation is updated within an event.

3. The method of claim 1, where the reordering activity that occurs to the one or more detected events is based on time and date such that:
changes to any of the one or more detected events will update the time and date information,
synchronization messages from other associated one or more associated activity screens will update the time and date information,
conversation messages within the one or more detected events will update the time and date information,
individual conversation events will also update the time and date information for their event.

4. The method of claim 1, such that:
the one or more detected events can be a photograph entered into the system and selected by the user to include on the activity screen.

5. The method of claim 1, such that:
the conversation messages can be compressed and summarized with a number and only the last few messages are shown in the user interface.

6. The method of claim 1, such that:
each of the conversation messages will have an identifier as to who authored the conversation message such that,
when conversation messages are entered to the one or more detected events an association is build between the conversation messages and the one or more detected events.
